(19) United States
(12) Patent Application Publication
(10) Pub. No.: US 2023/0111576 A1
(43) Pub. Date: Apr. 13, 2023

(54) PULSATOR

(71) Applicants: Lanny Gehm, Lisle, NY (US); William Gehm, Lisle, NY (US)

(72) Inventors: Lanny Gehm, Lisle, NY (US); William Gehm, Lisle, NY (US)

(21) Appl. No.: 18/066,096

(22) Filed: Dec. 14, 2022

Related U.S. Application Data
(62) Division of application No. 16/821,635, filed on Mar. 17, 2020.

(51) Int. Cl. A01J 5/16; A01J 5/04; A01J 5/007

(52) U.S. Cl. CPC A01J 5/16; A01J 5/047; A01J 5/0075; A01J 5/01

(57) ABSTRACT

A system and method for verifying proper milking system performance during the milking process. The system and method incorporates an integral function within a pulsator valve device that routinely performs functional evaluations and is capable of reporting results to the user. An additional air valve apparatus can be used to supply additional air to the pulsator valve device.

### FIELD OF THE INVENTION

The present invention pertains to an improvement of a pulsator device for milking domesticated animals and, more particularly to a pulsator which provides integral performance verification and improved reliability.

### DESCRIPTION OF RELATED ART

Modern milking systems have grown in size and complexity with the incorporation of sensors and meters to measure and detect milk flow and quantity of milk yielded by individual animals and automated action of both the attach and detach of the milking unit, or cluster, on the animal. The fundamentals of milking the animal have not changed, while the size and complexity has impacted the performance of the milking action on the animal. It remains critical to ensure proper treatment of the teat end of the animal throughout the milking process.

The incorporation of technology to improve automation of the milking process and the increase in size of milking facilities makes it challenging to ensure continuous proper function of the milking system. The need to milk many animals per hour in a facility substantially reduces time and ability of operators to recognize functional failures of the milking equipment. Those failures can reduce milking performance and result in damage to both the animals and the equipment. Some conventional products are designed to monitor portions of the milking system and provide notification to the user of a functional performance problem.

U.S. Pat. No. 7,841,296 discloses a complex pulsator control system with a method of determining when to start the pulsator, signals to operate the pulsator, sensors gathering data from the pulsator outputs that provide signals to a processor that then compares those signals to stored reference signals that are used to determine if the gathered data is within acceptable limits. US'296 requires the storing of a variety of acceptable signals for a range of milking system and pulsation operating parameters.

U.S. Pat. No. 7,450,021 discloses a vacuum system capacity analyzer that provides a method of routinely evaluating the vacuum capacity and capability of a milking system vacuum pump and associated vacuum regulator. US'021 requires the installation of an upstream and a downstream vacuum sensor to measure vacuum levels that are used to evaluate vacuum pump and regulator performance US'021 also discloses the installation of a separate air admission valve assembly to periodically admit air while the sensors measure vacuum response of the system. Vacuum responses and performance outside of set limits are declared to represent a failed condition.

U.S. Pat. No. 5,697,325 discloses a pulsator that incorporates two valves that work in a coordinated manner to provide the intended pulsator function of alternating a supply of vacuum and air to a pulsation chamber. The pulsator has one valve dedicated to the supply of fresh air with another valve dedicated to the supply of vacuum with the two valves never simultaneously connected to the pulsator outlet. The controller operating the valves provides signals that activate the valves such that each valve is open for the full duration of the time in which each respective valve is intended to maintain either air or vacuum in the pulsation chamber.

### SUMMARY OF THE INVENTION

It is recognized that embodiments of the present invention allow for an automated approach to detect and make known a functional failure of the pulsator and associated components of the milking system.

The present invention improves prior art pulsator apparatuses by incorporating an integrated sensor feature into the dedicated pulsator controller with the dedicated pulsator controller commanding the activation and deactivation of valves to provide vacuum and air to a pulsation chamber. The integrated sensor provides the controller with vacuum and air measurements that are synchronized with the controller commands to the pulsator valves. This approach provides a local command and verify function within the pulsator that does not require a separate central processor and does not require stored reference signals to determine if the pulsator is providing the intended function. As a result, the pulsator continuously verifies that the command from the controller to the valves has been received and properly acted upon. If the controller receives information from the sensor that does not align with the command to the valve, the controller can declare a failed condition and provide an alert to the user. The controller can also take action to attempt to resolve the detected failure by changing timing of the activation of the valves.

The present invention further improves prior art pulsator apparatuses having two valves that work in a coordinated manner to provide the intended pulsator function of alternating a supply of vacuum and air to a pulsation chamber. In an embodiment of the present invention the duration of time in which the valves are activated is substantially reduced, such that the activation time is less than the time in which the pulsator is respectively maintaining either vacuum or air in the pulsation chamber. This reduction in activation time permits the duration of time in which the pulsation chamber is at the intended pressure level to be longer than the activation time of the valve supplying the intended pressure to the pulsation chamber. This permits the pulsator to operate such that the opportunity to pull liquid up from the pulsation chamber is greatly reduced upon the failure of the flexible liner within the pulsation chamber that unintentionally permits liquid to enter the pulsation chamber. Vacuum is required to pull liquid up the hoses from the pulsation chamber and into the pulsator. If the duration of time that the vacuum valve is open is less than the time that the air valve is open, then less liquid will be drawn up. The same is true for any reduction in vacuum valve activation time. The reduction in volume of liquid drawn up into the pulsator is further reduced with the addition of a positive pressure fresh air source to the pulsator fresh air inlet.

Furthermore, the sensor detecting the air and vacuum levels of the pulsator output can detect the failure of the liner by detecting the presence of a vacuum in the pulsator output when only air should be present. The failure of a liner will permit the vacuum inside the liner to pass through the hole or slit at the location of the liner failure, which will create a vacuum within the pulsation chamber and pulsator output instead of being air which was previously admitted by the previously closed pulsator air valve. With the present invention having previously deactivated the air valve while maintaining the vacuum valve, also being deactivated, there is no source of vacuum from the pulsator, therefore the sensing of a vacuum is known to be a failure.

Furthermore, the present invention permits the detection of the leaking of a hose or other connections between the pulsator vacuum valve outlet and the pulsation chamber. The deactivation of the vacuum valve creates a sealed volume between the two pulsator valves and the pulsation chamber until the air valve is opened. The sensor can monitor that pulsator output to verify that the applied vacuum remains present until the air valve is activated. A reduction in in vacuum indicates a leak in the system that can then be measured by the sensor and the user notified of the failure. The pulsator controller can also again activate either the vacuum or air valves as required to ensure that the pulsator output remains as intended until the user can address either of the detected failures.

Furthermore, the present invention includes a humidity sensor to enable the detection of liquid in the air passing through the pulsator from the pulsation chamber. A rise in humidity level is an indication of a failed liner that is permitting the passage of liquid from the liner interior to the pulsation chamber. Furthermore, a separate air valve can be added to the pulsator to provide an additional air inlet source if it is determined that the pulsator air supply is insufficient.

In an embodiment, a method of integrating an automated functional performance feature into each individual pulsator is disclosed. Additionally, a method of automating the detection of the failure of other components connected to the pulsator is disclosed. The purpose of the pulsator is to provide an alternating source of vacuum and air to a pulsation chamber of a shell to cause the flexible liner in the shell to open and close around the teat of the animal being milked. The failure of the pulsator to provide the intended alternating vacuum and air can cause the liner to fail to open and close as desired. The physical failure of a liner in the form of a hole or slit can also cause the liner to not open and close correctly as well as cause either milk or washing liquids to be sucked up into the pulsator and milking system vacuum pump. It is also possible for hoses and connecting features between the pulsator and the shell to leak and admit air. Additionally, the vacuum pump supplying vacuum to the milking system can degrade with time, resulting in the pump not providing adequate vacuum during all times of the milking process. Embodiments of the present invention disclose an automated method of a pulsator to continuously monitor performance and to provide the user with an indication of performance that is not within specified limits.

### BRIEF DESCRIPTION OF THE DRAWING

FIG. 1 shows a schematic of the performance monitoring controller and associated pulsator apparatus of the present invention.

FIG. 2 shows a pulsator apparatus with the top cover removed and control card separated.

FIG. 3 shows a schematic of a control system of the present invention.

FIG. 4 shows a schematic of the of the various timing options of the present invention.

FIG. 5 shows a schematic of the of the various timing options of the present invention.

FIG. 6 shows a schematic of a pulsator apparatus with two dependent valves, with one valve dedicated to vacuum and the other valve dedicated to air.

FIG. 7 shows a schematic of an air valve apparatus to provide additional air to a pulsation chamber.

FIG. 8 is a flow diagram of a method of the pulsation controller indicating a detected failure.

FIG. 9 is a flow diagram of a method of the pulsation controller altering the timing of power applied to the solenoid to attempt to correct for a detected failure.

FIG. 10 is a flow diagram of a method of detecting a failure by the pulsation controller and notifying a user of the detected failure.

FIG. 11 shows a schematic of a pulsator apparatus with two dependent valves, with one valve dedicated to vacuum and the other valve dedicated to air with a valve providing a positive closure force.

FIG. 12 shows a schematic of a valve assembly of a pulsator apparatus with two dependent valves with the valve in a closed position providing a positive closure force.

### DETAILED DESCRIPTION OF THE INVENTION

Current milking systems are subject to functional failures of: the pulsators, the connecting hoses between the pulsators and the shell, the liners within the shells and the functional degradation of the pumps supplying vacuum to the milking system. Embodiments of the present invention seek to detect and identify those issues as soon as possible by routinely and continuously checking the vacuum and air pressure levels at the pulsator output to verify that they match the command from the controller to the pulsator valves supplying the air and vacuum to the output.

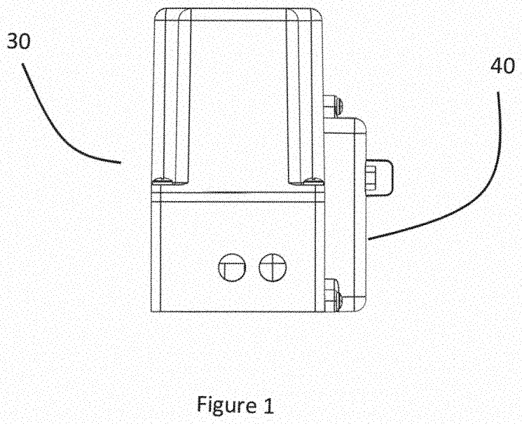

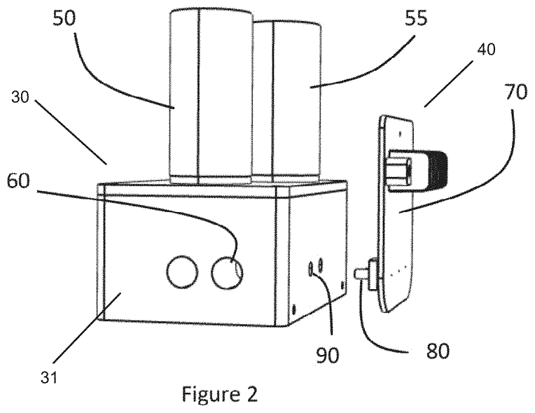

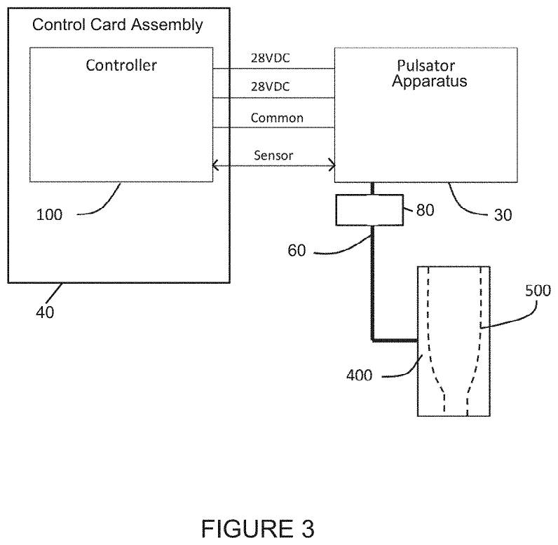

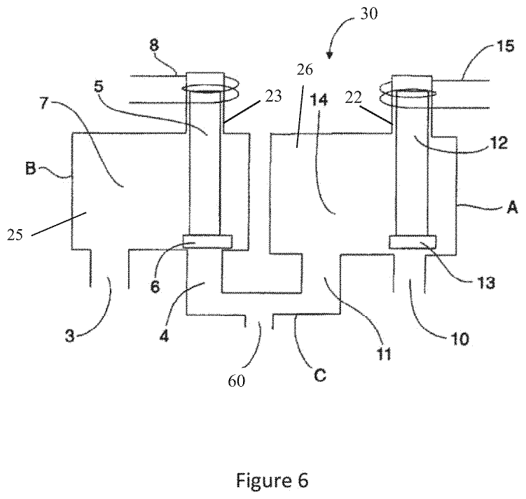

FIGS. 1-2 show a pulsator apparatus 30 with a controller card assembly 40. The control card assembly 40 includes a controller card 70 having a controller 100 and a sensor 80 which interfaces with a port 90 of the pulsator apparatus 30. The control card 70 may be integral to the pulsator apparatus 30. The controller card 70 may be integrally formed with the pulsator apparatus 30. The controller card 70 provides power to solenoids 50, 55 to operate the pulsator valves 7, 14 (see FIG. 6). Pulsator output 60 provides alternating vacuum and air to a pulsation chamber 400 (see FIG. 3). Sensor 80 of controller card assembly 40 interfaces with a port 90 in the base 31 of the pulsator apparatus 30 to measure the pressure levels in pulsator output 60.

Referring to FIG. 3, pulsation controller 100 of the control card assembly 40 provides power (28 VDC and Common) to the valves 7, 14 (see FIG. 6) within pulsator apparatus 30 which controls the pulsator output 60. Pulsation controller 100 receives input from a sensor 80 that measures the pressure level within the pulsator output 60 as well as duration between vacuum and air supplied to the pulsator output 60. The sensor 80 can alternatively measure humidity of pulsator output 60. Alternatively, an additional sensor can be used to measure humidity. The pulsator output 60 is connected to pulsation chamber 400 with tubing. Pulsation chamber 400 contains a flexible liner 500 that opens and closes with the supply of either vacuum or air respectively from the pulsator output 60. The pulsation controller 100 additionally includes a processor (not shown) which can compare the input from the sensor 80 of at least the measured level of vacuum or air to the pulsator output 60 to system operating levels stored in memory (not shown). Additionally the processor can compare duration between vacuum being supplied to the output 60 of the pulsator apparatus 30 and/or the duration of air being supplied to the output 60 of the pulsator apparatus 30 to stored or programmed controller timed settings. If the comparison of the input from the sensor 80 of the measured level of the vacuum or air is greater than or less than a threshold, a notification can be sent or indicated to the user.

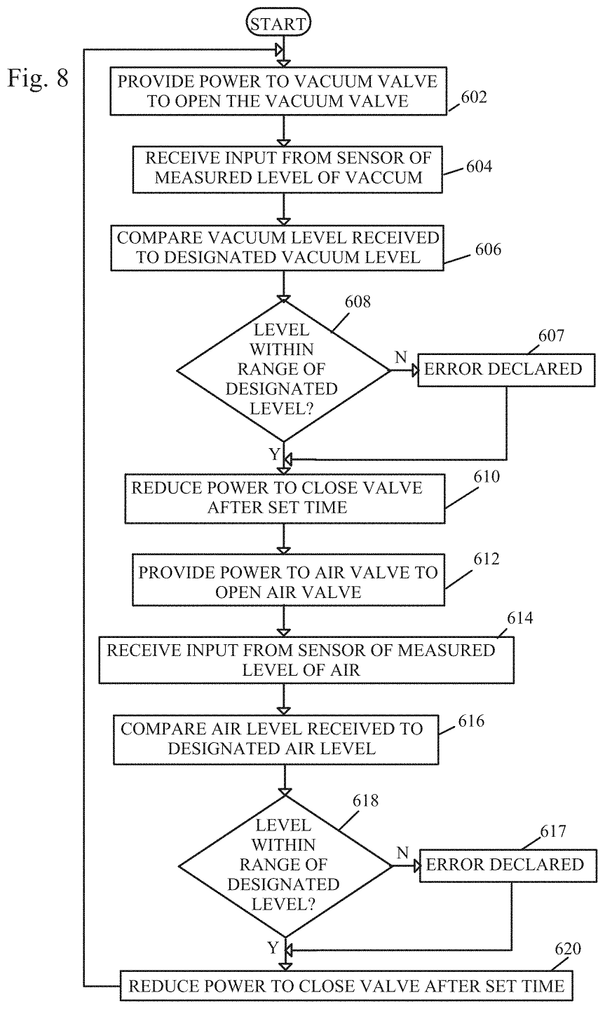

FIG. 8 is a flow diagram of a method of the pulsation controller indicating a detected failure of the pulsation apparatus.

In a first step (step 602), the pulsation controller 100 provides power to the solenoid 55 of the vacuum valve 14 to open the vacuum valve 14 of the pulsator apparatus 30.

The pulsation controller 100 receives input from the sensor 80 of a measured level of vacuum of the pulsator output 60 (step 604).

The pulsation controller 100 then compares vacuum level received to a designated vacuum level (step 606).

If the vacuum level of the pulsator output 60 is within a range of the designated level (step 608), the method continues to step 610 of the pulsation controller 100 reducing the power of the solenoid 55 to close the vacuum valve after a set duration of time.

If the vacuum level is not within range of the designated level (step 608), an error is declared by the pulsation controller 100 (step 607) and the method continues to step 610 of the pulsation controller 100 reducing the power to the solenoid 55 close the valve after a set duration of time.

The pulsation controller 100 then provides power to the air valve 7 of the pulsator apparatus 30 (step 612).

The pulsation controller 100 receives input from the sensor 80 of a measured level of air of the pulsator output 60 (step 614).

The pulsation controller 100 then compares the air level received to the a designated air level (step 616).

If the air level is within a range of the designated level (step 618), the method continues to step 620 of the pulsation controller 100 reducing the power to solenoid 50 to close the air valve 7 after a set duration of time and the method returns to step 602.

If the air level is not within range of the designated level (step 608), an error is declared by the pulsation controller 100 (step 617) and the method continues to step 620 of the pulsation controller 100 reducing the power to close the air valve 7 after a set duration of time and the method returns to step 602.

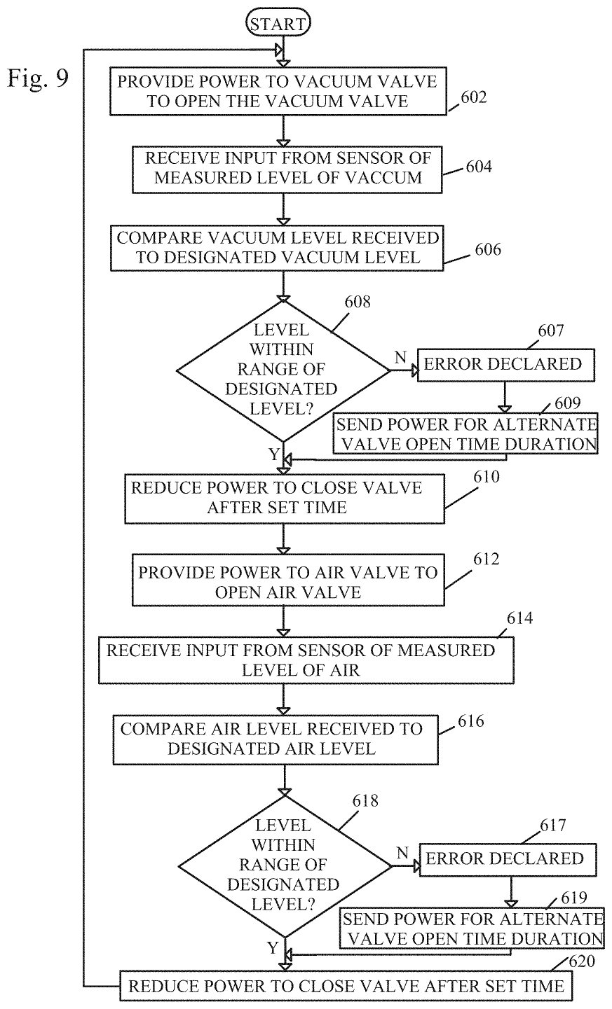

FIG. 9 is a flow diagram of a method of the pulsation controller altering the timing of power applied to the solenoid to attempt to correct for a detected failure.

In a first step (step 602), the pulsation controller 100 provides power to the solenoid 55 of the vacuum valve 14 to open the vacuum valve 14 of the pulsator apparatus 30.

The pulsation controller 100 receives input from the sensor 80 of a measured level of vacuum of the pulsator output 60 (step 604).

The pulsation controller 100 then compares vacuum level received to a designated vacuum level (step 606).

If the vacuum level of the pulsator output 60 is within a range of the designated level (step 608), the method continues to step 610 of the pulsation controller 100 reducing the power of the solenoid 55 to close the vacuum valve after a set duration of time.

If the vacuum level is not within range of the designated level (step 608), an error is declared by the pulsation controller 100 (step 607).

The pulsation controller 100 then provides power to the solenoid 55 of the vacuum valve 14 to open the vacuum valve 14 of the pulsator apparatus for an alternate duration (step 609) and the method continues to step 612. Step 609 is an attempt by the controller to correct for the detected failure. The duration of time may be increased or decreased based on the comparison of the vacuum level to the designated vacuum level.

The pulsation controller 100 then provides power to the air valve 7 of the pulsator apparatus 30 (step 612).

The pulsation controller 100 receives input from the sensor 80 of a measured level of air of the pulsator output 60 (step 614).

The pulsation controller 100 then compares the air level received to the a designated air level (step 616).

If the air level is within a range of the designated level (step 618), the method continues to step 620 of the pulsation controller 100 reducing the power to solenoid 50 to close the air valve 7 after a set duration of time and the method returns to step 602.

If the air level is not within range of the designated level (step 608), an error is declared by the pulsation controller 100 (step 617).

The pulsation controller 100 then provides power to the solenoid 55 of the vacuum valve 14 to open the vacuum valve 14 of the pulsator apparatus for an alternate duration (step 619) and the method continues to step 602. Step 619 is an attempt by the controller to correct for the detected failure. The duration of time may be increased or decreased based on the comparison of the air level to the designated air level.

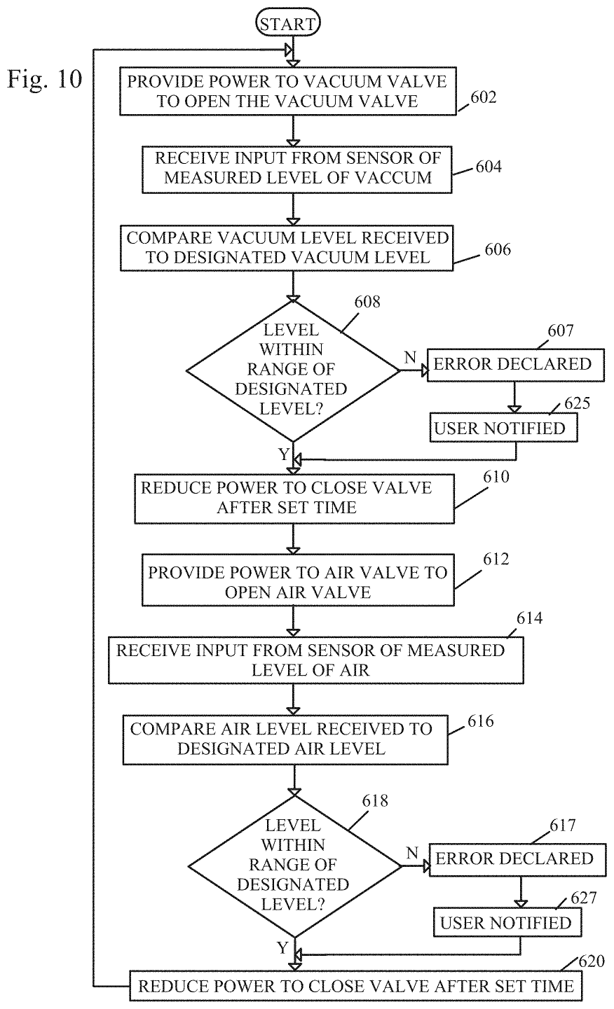

FIG. 10 is a flow diagram of a method of detecting a failure by the pulsation controller and notifying a user of the detected failure.

In a first step (step 602), the pulsation controller 100 provides power to the solenoid 55 of the vacuum valve 14 to open the vacuum valve 14 of the pulsator apparatus 30.

The pulsation controller 100 receives input from the sensor 80 of a measured level of vacuum of the pulsator output 60 (step 604).

The pulsation controller 100 then compares vacuum level received to a designated vacuum level (step 606).

If the vacuum level of the pulsator output 60 is within a range of the designated level (step 608), the method continues to step 610 of the pulsation controller 100 reducing the power of the solenoid 55 to close the vacuum valve after a set duration of time.

If the vacuum level is not within range of the designated level (step 608), an error is declared by the pulsation controller 100 (step 607). The pulsation controller 100 then generates a notification to be sent to the user (step 625) and the method continues to step 612.

The pulsation controller 100 then provides power to the air valve 7 of the pulsator apparatus 30 (step 612).

The pulsation controller 100 receives input from the sensor 80 of a measured level of air of the pulsator output 60 (step 614).

The pulsation controller 100 then compares the air level received to the a designated air level (step 616).

If the air level is within a range of the designated level (step 618), the method continues to step 620 of the pulsation controller 100 reducing the power to solenoid 50 to close the air valve 7 after a set duration of time and the method returns to step 602.

If the air level is not within range of the designated level (step 608), an error is declared by the pulsation controller 100 (step 617).

The pulsation controller 100 then generates a notification to be sent to the user (step 627) and the method continues to step 612.

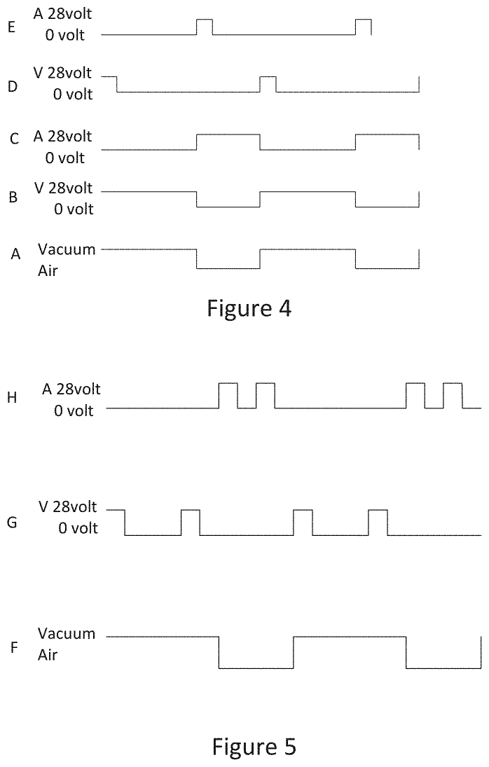

Referring to FIG. 4, timing schematics are provided for the pulsator output pressure and associated timing of power provided to the pulsator valves 7, 14. Schematic A of FIG. 4 provides the timing of the vacuum and air provided to the pulsation chamber 400 with this repetitive timing continuing for the duration of the milking process. The ratio of time with vacuum applied versus air applied can be constant or vary during the milking process as determined by the controller 100. Schematic B provides the associated timing of the power supplied by the controller 100 to the pulsator valve 14 providing vacuum (V) to the pulsator output 60. Schematic C provides the associated timing of the power supplied by the controller 100 to the pulsator valve 7 supplying air (A) to the pulsator output 60. A pulsator apparatus 30 having two dependent valves 7, 14 with one valve 14 controlling vacuum and the other valve 7 controlling air requires two power signals coordinated as shown in schematics B and C. A conventional pulsator having one valve providing both vacuum and air requires only one power signal as provided in schematic B. A pulsator apparatus 30 having two dependent valves 7, 14 with one valve 14 controlling vacuum and the other valve 7 controlling air has the capability of reducing the time power is applied to the valves 7, 14 without reducing the time that the pulsator apparatus 30 provides either vacuum or air. Schematic D provides an example of the possible associated timing of the power supplied by the controller 100 to the pulsator valve 14 providing vacuum (V) to the pulsator output 60 for a pulsator apparatus 30 having two dependent valves 7, 14 that enables to ability to detect a leak in the pulsation system. Schematic E provides an example of the possible associated timing of the power supplied by the controller 100 to the pulsator valve 7 supplying air (A) to the pulsator output 60 for a pulsator apparatus 30 having two dependent valves 7, 14 that enables the ability to detect a failure in the liner 500.

Referring to FIG. 5, timing schematics are provided for the pulsator output pressure and associated timing of power provided to the pulsator valves 7, 14 of a pulsator apparatus 30 having two dependent valves 7, 14 with one valve 14 supplying vacuum (V) and the other valve 7 supplying air (A). Schematic G provides an example of the possible associated timing of the power supplied by the controller 100 to the pulsator valve 14 providing vacuum (V) to the pulsator output 60 for a pulsator apparatus 30 having two dependent valves 7, 14 that enables to ability to activate the vacuum valve 14 a second time when the sensor 30 has detected a leak in the pulsation system in order to maintain the pulsator valve 14 in an open condition for the duration desired. Schematic H provides an example of the possible associated timing of the power supplied by the controller 100 to the pulsator valve 7 supplying air (A) to the pulsator output 60 for a pulsator apparatus 30 having two dependent valves 7, 14 that enables the ability to activate the pulsator valve 7 supplying air a second time when the sensor 80 has detected a leak in the liner 500. The second activation permits the pulsator apparatus 40 to continue providing air to reduce the movement of liquid from the pulsation chamber 400 into the pulsator apparatus 30. It is possible for the controller 100 to have a duration of the second activation that fills the time between the end of the first activation and the end of the time required for the valve 7, 14 to provide the required air or vacuum, for example as shown in FIG. 5F. The duration of the second activation can either be for a short duration or the full remaining duration of the time period to supply either vacuum or air. For example in FIG. 5G there are two power events for the vacuum solenoid however the figure shows the second activation to end prior to the end of the total vacuum cycle duration in FIG. 5F.

Referring to FIG. 6, a schematic is shown for a pulsator apparatus 30 having two valves 7 and 14, with valve 14 controlling the supply of vacuum 10 and valve 7 controlling the supply of air 3 to the common pulsator output 60. Solenoid 50 provides power to open air valve 7 and solenoid 55 provides power to open vacuum valve 14. The solenoid 50, 55 is an assembly including a housing with a wound wire assembly or solenoid coil 8, 15 having a moveable plunger 5, 12. Port 90 of FIG. 2 provides a flow path between sensor 80 of FIG. 2 and the common pulsator output 60. The pulsator apparatus 30 includes three channels, A, B and C, with channel A controlling the vacuum inlet 10, and channel B controlling the atmospheric air pressure inlet 3 Channel A has a chamber 26, and channel B has a chamber 25. Chamber 26 has a vacuum pressure outlet 11 and a vacuum pressure inlet 10 Chamber 25 comprises an atmospheric air pressure outlet 4 and an atmospheric air pressure inlet 3. The air pressure supplied is preferably at or above atmospheric pressure.

Received within chamber 26 of channel A and solenoid housing 22 is a biased solenoid valve plunger 12, forming a first valve 14. An end of the biased solenoid valve plunger 12 has a seal 13 and is biased against vacuum pressure inlet 10 in chamber 26. A solenoid coil 15 is actuated to move the solenoid valve plunger 12 against its biasing, in order to open vacuum pressure inlet 10.

Received within chamber 25 of channel B and solenoid housing 23 is a biased solenoid valve plunger 5, forming a second valve 7. An end of the biased solenoid valve plunger 5 has a seal 6 and is biased against atmospheric air pressure outlet 4. A solenoid coil 8 is actuated to move the solenoid valve plunger 5 against its biasing, in order to open atmospheric air pressure outlet 4. The atmospheric air pressure outlets 4 and vacuum pressure outlet 11 open upon third channel (channel C), having pulsator outlet 60.

A control circuit actuates either the solenoid valve plunger 12 biased against the vacuum pressure inlet 10 in chamber 26 or the solenoid valve plunger 5 biased against the atmospheric air pressure outlet 4 to open. The control circuit would ensure that only one of the valves is open at any one given time, i.e. only one of the respective solenoid valve plungers 5, 12 is lifted at any given time. This prevents the pulsator output 60 in channel C from being simultaneously connected to both the atmospheric air pressure inlet 3 of the channel B and the vacuum pressure inlet 10 of channel A.

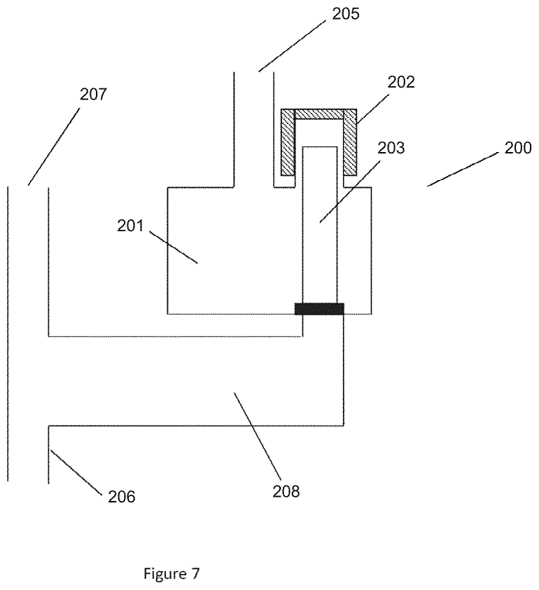

Referring to FIG. 7, a schematic is shown for an air valve apparatus 200 for supplying air to a pulsation chamber 400 in addition to that from the pulsator apparatus 30. Port 207 connects to the output port 60 of a pulsator apparatus 30 has a port 206 output connecting to the pulsation chamber 400. Solenoid 202 receives power from the pulsation controller 100 to activate the valve to permit air from air inlet 205 connected to an air source to enter chamber 201 and pass through into outlet 208 to supply air to port 206 when the air valve 203 is open.

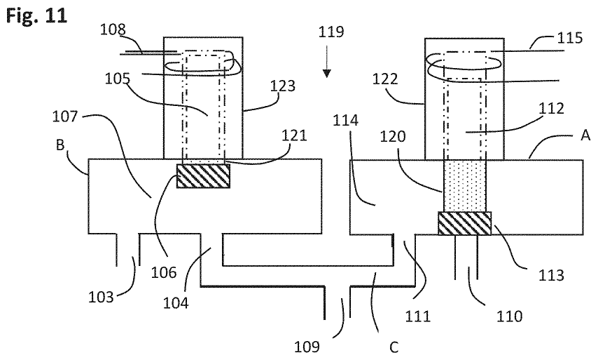

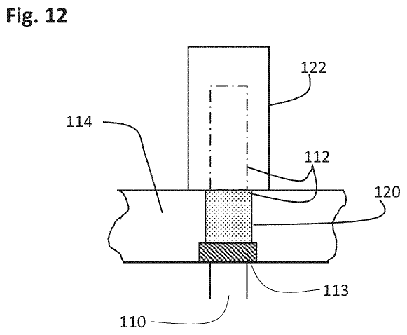

Referring to FIG. 11, a pulsator 119 includes three channels, A, B and C, with channel A controlling the vacuum inlet 110, and channel B controlling the atmospheric air pressure inlet 103. Channel A has a chamber 114, and channel B has a chamber 107. Chamber 114 has a vacuum pressure outlet 111 and a vacuum pressure inlet 110 Chamber 107 comprises an atmospheric air pressure outlet 104 and an atmospheric air pressure inlet 103.

Received within chamber 114 of channel A and solenoid housing 122 is a compressible force member 120 and a solenoid valve plunger 112, forming a first valve. An end of the solenoid valve plunger 112 has a seal 113 and is biased against vacuum pressure inlet 110 in chamber 114. A solenoid coil 115 is powered to move the solenoid valve plunger 112 against its biasing, in order to open vacuum pressure inlet 110. The compressible force member 120 has an uncompressed height equal to or greater than the distance the solenoid valve plunger 112 travels when fully extended from the solenoid housing 122 in order to provide a positive force function when seal 113 and plunger 112 close against the base of chamber 114. Furthermore, compressible force member 120 must be capable of being compressed a substantial percentage of the total uncompressed height so that solenoid valve plunger 112 can properly retract within solenoid housing 122.

Referring to FIG. 12, a detailed partial section of chamber 114 relative to solenoid housing 122 and solenoid valve plunger 112 with the flexible force member 120 shown with the solenoid valve plunger 112 down in the closed state with compressible force member 120 providing a positive closure force on seal 113 against the base of chamber 114. Compressible force member 120 can be an elastomer, spring or other mechanism capable of expanding and contracting with the movement of the solenoid valve plunger 112.

Accordingly, it is to be understood that the embodiments of the invention herein described are merely illustrative of the application of the principles of the invention. Reference herein to details of the illustrated embodiments is not intended to limit the scope of the claims, which themselves recite those features regarded as essential to the invention.

1. A controller for a pulsator apparatus, the controller comprising:
an input from a sensor connected to an output of the pulsator apparatus representing a measured level of vacuum or air being supplied by the pulsator apparatus to a pulsation chamber;
a processor comparing the input from the sensor of the measured level of vacuum or air to system operating levels being supplied to the output of the pulsator apparatus to programmed controller timed settings to generate a first output or a second output;
a first output providing a signal to a valve of the pulsator apparatus to allow flow of either vacuum or air to a pulsation chamber; and
a second output providing a notification to a user indicating a function of the pulsator apparatus is not meeting system operating levels.

2. The controller of claim 1, wherein the sensor measures humidity present in the output of the pulsator.

3. The controller of claim 1, wherein the input from the sensor further comprises duration between vacuum and air being supplied to the output of the pulsator apparatus and the processor comparing the input from the sensor of the duration between vacuum and air being supplied to the output of the pulsator apparatus to programmed controller timed settings to generate a first output or a second output.

4. (canceled)

5. (canceled)

6. (canceled)

7. (canceled)

8. (canceled)

9. (canceled)

10. (canceled)

11. (canceled)

12. (canceled)

13. (canceled)

14. (canceled)

15. (canceled)

16. (canceled)

17. (canceled)

18. (canceled)

19. (canceled)

20. (canceled)

21. (canceled)

22. (canceled)

23. (canceled)
